(19) United States
(12) Patent Application Publication
(10) Pub. No.: US 2023/0231152 A1
(43) Pub. Date: Jul. 20, 2023

(54) Proton Exchange Membrane Fuel Cell and Preparation Method Therefor, and Proton Exchange Membrane Fuel Cell Stack

(71) Applicant: Robert Bosch GmbH, Stuttgart (DE)

(72) Inventor: Xiaogang Hao, Shanghai (CN)

(21) Appl. No.: 17/998,327

(22) PCT Filed: May 14, 2020
(86) PCT No.: PCT/CN2020/090304

§ 371 Date: Nov. 9, 2022

(51) Int. Cl. H01M 8/0245; H01M 4/88

(52) U.S. Cl. CPC H01M 8/0245; H01M 4/8807

(57) ABSTRACT

A proton exchange membrane fuel cell that uses hydrogen peroxide as an oxidant is disclosed. The proton exchange membrane fuel cell includes an anode gas diffusion layer, an anode catalyst layer, a proton exchange membrane and a cathode catalyst layer arranged sequentially. The proton exchange membrane fuel cell further includes a single electrode plate, and does not include a cathode gas diffusion layer. A cell stack including the proton exchange membrane fuel cell is also disclosed, as well as a method for preparing the proton exchange membrane fuel cell.

### TECHNICAL FIELD

The present invention relates to a proton exchange membrane fuel cell and a method for preparing same, and a cell stack comprising the proton exchange membrane fuel cell.

### BACKGROUND ART

Faced with the grave challenges of global warming, atmospheric pollution and depletion of energy sources, new energy vehicles and energy conservation/emissions reduction have become a top priority in the automotive industry, pushing the transformation from traditional internal combustion engine vehicles to the more environmentally friendly new energy electric vehicles. In electric vehicles, fuel cells and especially proton exchange membrane (PEM) cells have received widespread attention as a very promising, efficient and environmentally friendly power source.

PEM fuel cells use hydrogen as fuel and oxygen or air as an oxidant, converting chemical energy to electrical energy by an electrochemical method, and discharging water, thus achieving zero emissions in a real sense. Furthermore, due to the use of a solid polymer membrane as an electrolyte, PEM fuel cells also have advantages such as a high energy conversion rate, low-temperature starting, and no electrolyte leakage.

As shown in FIG. 1, a conventional PEM fuel cell unit generally comprises, arranged sequentially, an anode plate 23, an anode gas diffusion layer 22, a membrane electrode assembly (MEA, comprising an anode catalyst layer 21, a PEM 10 and a cathode catalyst layer 31), a cathode gas diffusion layer 32 and a cathode plate 33.

Conventional PEM fuel cells generally use air or oxygen as an oxidant. However, because oxygen reduction has a high activation energy barrier, fuel cells generally have high overpotential, and consequently, the working voltage (e.g. about 0.6-0.7 V) is lower than the standard voltage (e.g. about 1.23 V). Furthermore, to increase the power density of PEM fuel cells, it is usually necessary to use a compressor to compress the air to 1-3 bars before it is fed; this increases equipment costs and process costs, and the energy consumption of the compressor will reduce the efficiency of the fuel cell (generally lower than 50%). In addition, if water management is not designed rationally, water overflow will impair the performance of the fuel cell.

Thus, there is still a need to improve PEM fuel cells, in order to improve the PEM fuel cell performance and reduce costs.

### SUMMARY OF THE INVENTION

To this end, in one aspect, the present disclosure provides a proton exchange membrane fuel cell, wherein the proton exchange membrane fuel cell uses hydrogen peroxide as an oxidant,

the proton exchange membrane fuel cell comprises an anode gas diffusion layer, an anode catalyst layer, a proton exchange membrane and a cathode catalyst layer arranged sequentially,

the proton exchange membrane fuel cell further comprises a single electrode plate, and does not comprise a cathode gas diffusion layer.

In another aspect, the present invention further provides a proton exchange membrane fuel cell stack, comprising at least two proton exchange membrane fuel cells as described above, connected in series.

In another aspect, the present invention further provides a method for preparing a proton exchange membrane fuel cell, the method comprising:

sequentially arranging an anode gas diffusion layer, an anode catalyst layer, a proton exchange membrane and a cathode catalyst layer to obtain a laminated structure,

stamping a flat sheet material to obtain an electrode plate, and

fitting together the electrode plate and the laminated structure.

The proton exchange membrane fuel cell according to the present invention may be used in electric vehicles (such as automobiles), regional power stations and portable devices.

Referring to the following drawings, various other features, aspects and advantages of the present invention will become more obvious. These drawings are not drawn to scale, being intended to explain various structural and positional relationships schematically, and should not be construed as being limiting. In the drawings, identical reference labels in different views generally denote identical parts.

### BRIEF DESCRIPTION OF THE DRAWINGS

FIG. 1 is a schematic drawing of a proton exchange membrane fuel cell unit according to the prior art.

FIG. 2 is a schematic drawing of a proton exchange membrane fuel cell unit according to the present disclosure.

FIG. 3 is a schematic drawing of a proton exchange membrane fuel cell unit according to the present disclosure.

FIG. 4 is a sectional schematic drawing of an electrode plate according to the present disclosure.

FIG. 5 shows a top view of the cathode side of the electrode plate according to the present disclosure.

FIG. 6 shows a top view of the anode side of the electrode plate according to the present disclosure.

FIG. 7 is a schematic drawing of a proton exchange membrane fuel cell stack according to the present disclosure.

FIG. 8 is a schematic drawing of a proton exchange membrane fuel cell stack according to the present disclosure.

FIG. 9 is a schematic drawing of a proton exchange membrane fuel cell stack according to the present disclosure.

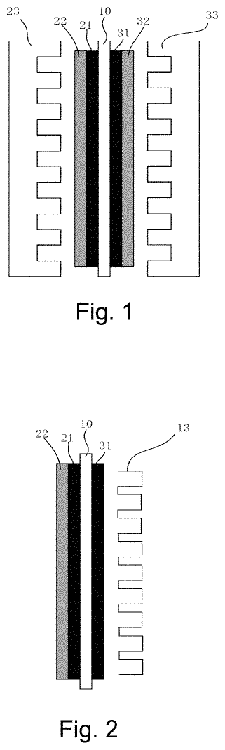

### DETAILED DESCRIPTION OF EMBODIMENTS

Unless otherwise defined, all technical and scientific terms used herein have the meanings commonly understood by those skilled in the art. In case of inconsistency, the definitions provided in the present application shall prevail.

In the context of the present text, unless otherwise explicitly stated, “cell”, “fuel cell” and “PEM fuel cell” can be used interchangeably.

Unless otherwise indicated, a range of values listed herein is intended to include the endpoints of the range, as well as all values and all sub-ranges within the range.

All materials, contents, methods, devices, drawings and instances herein are exemplary, and unless specifically stated, should not be construed as being limiting.

The terms “including”, “comprising” and “having” as used herein all indicate that other components or other steps that do not affect the final result may be included. These terms encompass the meanings of “consisting of . . . ” and “substantially consisting of . . . ”.

The product and method according to the present invention may include or comprise necessary technical features described in the present disclosure, as well as additional and/or optionally present components, constituents, steps or other limiting features described herein; or may consist of necessary technical features described in the present disclosure, as well as additional and/or optionally present components, constituents, steps or other limiting features described herein; or substantially consist of necessary technical features described in the present disclosure, as well as additional and/or optionally present components, constituents, steps or other limiting features described herein.

Unless otherwise explicitly stated, all materials and reagents used in the present disclosure are commercially available.

Unless otherwise indicated or there is a clear contradiction, all operations performed herein may be performed at room temperature and atmospheric pressure.

Unless otherwise indicated or there is a clear contradiction, the method steps in the present disclosure may be performed in any suitable order.

Embodiments of the present disclosure are described in detail below.

According to the present disclosure, an electrode plate for a PEM fuel cell is provided, comprising:

sequentially arranging an anode gas diffusion layer, an anode catalyst layer, a PEM and a cathode catalyst layer to obtain a laminated structure,

stamping a flat sheet material to obtain an electrode plate, and

fitting together the electrode plate and the laminated structure.

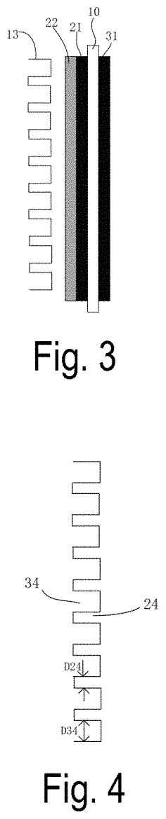

As shown in FIG. 2, a PEM fuel cell unit according to the present disclosure comprises, arranged sequentially, an anode gas diffusion layer 22, a membrane electrode assembly (MEA, comprising an anode catalyst layer 21, a PEM 10 and a cathode catalyst layer 31) and a single electrode plate 13. The electrode plate 13 may be located at an outer side of the cathode catalyst layer 31 (as shown in FIG. 2), or at an outer side of the anode gas diffusion layer 22 (as shown in FIG. 3).

In some embodiments, a metal screen is further provided at the outer side of the cathode catalyst layer 31.

In some embodiments, the electrode plate 13 is located at the outer side of the cathode catalyst layer 31, and a metal screen (not shown in FIG. 2) is further provided between the cathode catalyst layer 31 and the electrode plate 13. In some embodiments, the electrode plate 13 is located at the outer side of the anode gas diffusion layer 22, and a metal screen (not shown in FIG. 3) is located at the outer side of the cathode catalyst layer 31. The metal screen is used to provide physical protection for the cathode catalyst, preventing liquid from scouring the surface of the cathode catalyst 31 while flowing. The metal screen may for example comprise stainless steel, e.g. stainless steel 316.

Compared with oxygen, the use of hydrogen peroxide as an oxidant has numerous advantages:

since hydrogen peroxide is a liquid, there is no longer any need to use a gas diffusion layer at the cathode side.

This overcomes the problem of overpotential associated with conventional hydrogen/oxygen PEM fuel cells, so high cell efficiency can be achieved, e.g. greater than 60%.

A compressor is not needed, so it is possible to increase the total power efficiency of the cell and reduce costs.

In a conventional hydrogen/oxygen PEM fuel cell, gaseous oxidant and the product water are present at the cathode side, i.e. there is coexistence of two phases, gas and liquid. If water management is not designed rationally, water overflow will impair the performance of the fuel cell. In contrast, according to the present invention, at the cathode side there in only a single liquid phase formed of hydrogen peroxide, the product water and coolant, so the problem of water management no longer exists.

Since the density of the liquid reactant is higher than that of the gaseous reactant, the power density of the cell is also improved.

The present disclosure uses a single electrode plate to replace a conventional double electrode plate, so compared with a conventional PEM fuel cell, eliminates one electrode plate, reduces the thickness of the fuel cell, eliminates the double electrode plate bonding process (e.g. welding or gluing), and avoids the drawbacks associated with the double electrode plate bonding process (e.g. cost and damage to the electrode plate).

Furthermore, on the single electrode plate, a flow path on the cathode side may be used as a channel for hydrogen peroxide, product water and coolant simultaneously. In contrast, a conventional PEM fuel cell has a “three inlets, three outlets” design, i.e. an inlet and an outlet for fuel, an inlet and an outlet for oxidant, and an inlet and an outlet for coolant. The present disclosure uses a single electrode plate, combining a cathode plate with an anode plate, and also combining an oxidant channel with a coolant channel, thus simplifying the design, reducing starting material costs, and increasing the volume energy density of the cell.

In a conventional hydrogen/oxygen PEM fuel cell, expensive platinum is used as a cathode catalyst. Because hydrogen peroxide has very high activity, a cheaper metal (e.g. gold), alloy, metal oxide (e.g. iron oxide) and/or carbon may be used to replace some or all of the platinum as the cathode catalyst, thereby reducing the cost of the cell without sacrificing cell performance.

In some embodiments, the single electrode plate has a surface structure of alternately distributed protrusions and depressions. In some embodiments, the single electrode plate has a corrugated structure.

The electrode plate according to the present disclosure may be obtained by stamping a flat sheet material.

Grooves on the electrode plate are used as channels for reactants, product and/or coolant; these channels are also called flow paths. All of the flow paths are collectively called a flow field. As shown in FIG. 4, grooves at the two sides of the electrode plate are respectively used as anode flow paths 24 and cathode flow paths 34. The anode flow paths 24 are used as hydrogen channels. The cathode flow paths 34 are used as channels for hydrogen peroxide, product water and coolant simultaneously. Water is generally introduced as the coolant. The cooling efficiency may be controlled by adjusting the ratio and flow speeds of hydrogen peroxide and coolant (e.g. water).

In some embodiments, on the electrode plate, the width (or diameter) of the flow paths on the anode side is no greater than the width (or diameter) of the flow paths on the cathode side. Preferably, the width (or diameter) of the flow paths on the anode side is less than the width (or diameter) of the flow paths on the cathode side. For example, the ratio of the width (or diameter) D24 of the flow paths on the anode side to the width (or diameter) D34 of the flow paths on the cathode side is 0.5-1:1, preferably 0.5:1 to less than 1:1. The flow paths on the anode side are for the passage of hydrogen, while the flow paths on the cathode side are for the passage of hydrogen peroxide, product water and coolant (e.g. water). Compared with hydrogen peroxide and water, hydrogen has a lower flow rate. Thus, by designing the flow paths on the anode side to be narrower than the flow paths on the cathode side, the distribution efficiency of the flow field can be increased. Here, there are no particular restrictions on the shape of the flow paths, which may for example be cylindrical, semi-cylindrical, cuboid-shaped, prism-shaped, or another common shape, or any combination of these. Depending on the specific shape of the flow path, the width and diameter of the flow path are interchangeable.

There are no particular restrictions on the structure of the flow field; all flow field structures commonly used in PEM fuel cells are suitable for the present disclosure. For example, the flow field structure may be a dotted flow field, a mesh flow field, a parallel flow field, a serpentine flow field, a porous flow field, an interdigitated flow field, a corrugated flow field, a triangularly corrugated flow field, etc.

In some embodiments, holes are punched in the electrode plate, to provide an anode inlet, an anode outlet, a cathode inlet and a cathode outlet.

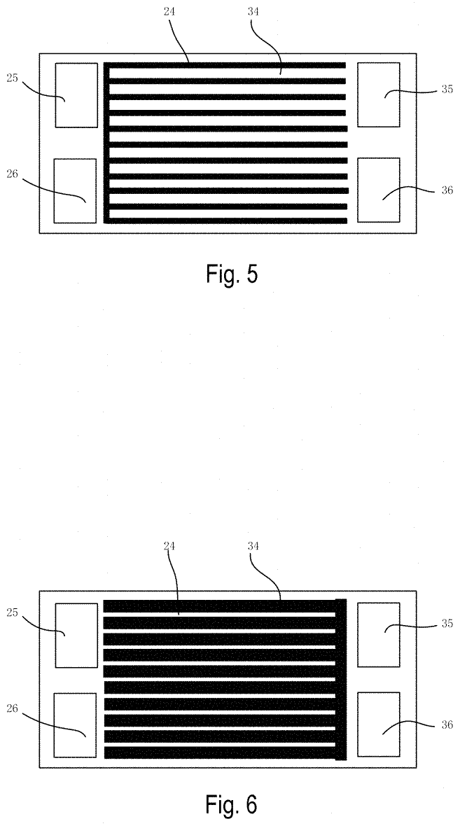

FIG. 5 shows a top view of the cathode side of the electrode plate according to the present disclosure. As shown in FIG. 5, a cathode inlet 35 and a cathode outlet 36 are connected to the cathode flow paths 34 of the electrode plate, providing channels for hydrogen peroxide, product water and coolant.

FIG. 6 shows a top view of the anode side of the electrode plate according to the present disclosure. As shown in FIG. 6, an anode inlet 25 and an anode outlet 26 are connected to the anode flow paths 24 of the electrode plate, providing flow paths for hydrogen.

In some embodiments, the material of the electrode plate may be metal, for example titanium or stainless steel, e.g. stainless steel 316L; or an alloy, e.g. a titanium alloy, aluminium alloy or nickel alloy; or graphite.

The thickness of the electrode plate may be about 0.08-about 0.1 mm.

The width (or diameter) of the anode flow paths may for example be about 0.2-about 0.6 mm; the width (or diameter) of the cathode flow paths may for example be about 0.2-about 1.2 mm, preferably about 0.3-about 0.8 mm. The groove depth of the flow paths may be about 0.2-about 0.6 mm, e.g. about 0.4 mm.

In some embodiments, both sides of the electrode plate have coatings (not shown in the figures). The coatings on the two sides of the electrode plate may be the same or different.

In some embodiments, a carbon coating is provided on both sides of the electrode plate, or at least on the side of the electrode plate that faces the cathode. The carbon coating may be at least one selected from carbon fiber, graphene and carbon nanotubes. The carbon coating may be formed by physical vapor deposition (PVD) or screen printing. By using the carbon coating, the hydrophobicity and corrosion resistance of the electrode plate can be improved, facilitating fluid flow.

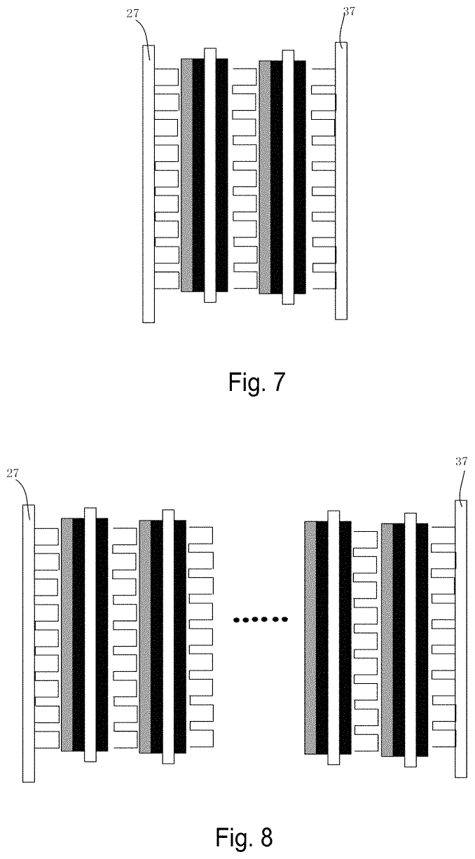

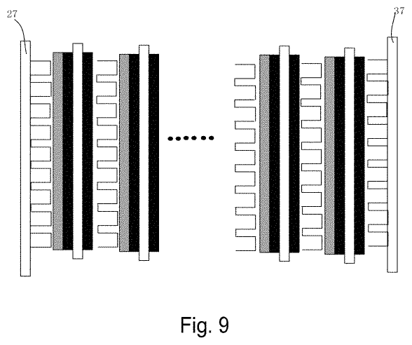

A PEM fuel cell stack according to the present disclosure comprises at least two of the PEM fuel cells described above, connected in series. FIGS. 7-9 are schematic drawings of PEM fuel cell stacks according to the present disclosure. In FIG. 7, the PEM fuel cell stack comprises two PEM fuel cells connected in series. In FIGS. 8 and 9, the PEM fuel cell stack comprises more than two, for example 3, 4, 5, 6, . . . , between ten and twenty, several tens of, more than a hundred, several hundred or more PEM fuel cells connected in series. Preferably, each PEM fuel cell in the cell stack is the same, i.e. the PEM fuel cells are connected together in series as repeating units. In FIGS. 7-9, an anode current collector 27 and a cathode current collector 37 are connected to two sides of the cell stack respectively. In FIG. 8, the electrode plate of the PEM fuel cell is located at the cathode side. In FIG. 9, the electrode plate of the PEM fuel cell is located at the anode side.

The present disclosure further provides a method for preparing a PEM fuel cell, the method comprising:

sequentially arranging an anode gas diffusion layer, an anode catalyst layer, a PEM and a cathode catalyst layer to obtain a laminated structure,

stamping a flat sheet material to obtain an electrode plate, and

fitting together the electrode plate and the laminated structure.

The step of arranging the laminated structure and the step of stamping the sheet material may be performed in any suitable order. For example, the sheet material may be stamped first, and then the layers of the laminated structure may be arranged. When arranging the laminated structure, the order in which the layers are arranged may also be adjusted as required.

1. A proton exchange membrane fuel cell that uses hydrogen peroxide as an oxidant, comprising:
an anode gas diffusion layer, an anode catalyst layer, a proton exchange membrane and a cathode catalyst layer arranged sequentially, and
a single electrode plate which is free of a cathode gas diffusion layer.

2. The proton exchange membrane fuel cell as claimed in claim 1, wherein the electrode plate is located at an outer side of the cathode catalyst layer.

3. The proton exchange membrane fuel cell as claimed in claim 1, wherein the electrode plate has a surface structure of alternately distributed protrusions and depressions.

4. The proton exchange membrane fuel cell as claimed in claim 1, wherein on the electrode plate, the width of a flow path on an anode side is no greater than the width of a flow path on a cathode side.

5. The proton exchange membrane fuel cell as claimed in claim 4, wherein on the electrode plate, the ratio of the width of the flow path on the anode side to the width of the flow path on the cathode side is 0.5-1.0:1.0.

6. The proton exchange membrane fuel cell as claimed in claim 1, wherein a side of the electrode plate that faces a cathode has a carbon coating.

7. The proton exchange membrane fuel cell as claimed in claim 6, wherein the carbon coating comprises at least one selected from carbon fiber, graphene and carbon nanotubes.

8. The proton exchange membrane fuel cell as claimed in claim 1, further comprising a metal screen provided at an outer side of the cathode catalyst layer.

9. A proton exchange membrane fuel cell stack, comprising at least two proton exchange membrane fuel cells, wherein:
each of the at least two proton exchange membrane fuel cells is as claimed in claim 1, and
the at least two proton exchange membrane fuel cells are connected in series.

10. A method for preparing the proton exchange membrane fuel cell as claimed in claim 1, the method comprising:
sequentially arranging an anode gas diffusion layer, an anode catalyst layer, a proton exchange membrane and a cathode catalyst layer to obtain a laminated structure,
stamping a flat sheet material to obtain an electrode plate, and
fitting together the electrode plate and the laminated structure.

11. The proton exchange membrane fuel cell as claimed in claim 8, wherein:
the electrode plate is located at the outer side of the cathode catalyst layer, and
the metal screen is located between the cathode catalyst layer and the electrode plate.

12. The proton exchange membrane fuel cell as claimed in claim 1, wherein the electrode plate is located at an outer side of the anode gas diffusion layer.
